(19) United States
(12) Patent Application Publication
(10) Pub. No.: US 2025/0268415 A1
(43) Pub. Date: Aug. 28, 2025

(54) DEVICE FOR FROTHING MILK AND COFFEE MACHINE INCLUDING SUCH DEVICE

(71) Applicant: DE' LONGHI APPLIANCES S.r.l., Treviso (IT)

(72) Inventors: Antonio PANCIERA, Treviso (IT); Simone ROSETTA, Treviso (IT); Eros SARTORI, Treviso (IT)

(73) Assignee: DE' LONGHI APPLIANCES S.r.l., Treviso (IT)

(21) Appl. No.: 18/859,395

(22) PCT Filed: Apr. 26, 2023
(86) PCT No.: PCT/EP2023/061008

§ 371 Date: Oct. 23, 2024

(30) Foreign Application Priority Data
May 3, 2022 (IT) 102022000008999

(51) Int. Cl. A47J 31/44; A47J 31/46; A47J 31/52; A47J 31/60; B01F 23/233; B01F 33/452; B01F 101/07

(52) U.S. Cl. CPC A47J 31/4489; A47J 31/461; A47J 31/52; A47J 31/60; B01F 23/233; B01F 33/452; B01F 2101/07

(57) ABSTRACT

The device for frothing milk comprises: a milk container provided with a lid with hermetic closure; a line for the pressurization of the container including an air supply pump; a line connecting the container to the external atmospheric environment including a shut-off valve; a Venturi effect milk suction chamber; a line for the inlet of milk into the milk suction chamber, wherein said milk inlet line comprises a conduit for withdrawing milk from said container; a line for the inlet of steam into the milk suction chamber for initiating the Venturi effect and for sucking milk from the milk container; a line for the outlet of milk from the suction chamber; a milk frothing chamber connected to said milk outlet line and internally provided with a mechanical stirrer.

### CROSS-REFERENCE TO RELATED APPLICATIONS

This is a U.S. National Phase Application under 35 U.S.C. 371 of International Patent Application No. PCT/EP2023/061008, filed Apr. 26, 2023, which claims benefit of priority to Italian Patent Application No. 102022000008999, filed May 3, 2022. The entire contents of these applications are hereby incorporated by reference.

### FIELD OF THE INVENTION

The present invention refers to a device for frothing milk and to a coffee machine including such device.

Devices for frothing milk that can be associated with a coffee machine have long been known. Some types of known devices comprise a milk container provided with a lid incorporating a Venturi effect mixing chamber where air and milk collected from the container are mixed by Venturi effect initiated by a steam flow.

The air access way to the mixing chamber can be provided with a progressively opening valve and by operating thereon the degree of frothing the milk can be modified.

One of the limitations of these types of known devices is the limited capacity to diversify the range of frothed milk that can be produced.

In particular, with these types of known devices it is not possible to produce cold-frothed milk as the steam flow that serves to initiate the Venturi effect and the withdrawal of milk heats the milk sucked into the mixing chamber.

Such known devices for frothing milk may complain of other drawbacks including the complexity of accessing internal components for inspection and cleaning.

This problem is quite relevant if one thinks that any milk residues that solidify inside the device can create blockages of the milk flow passage openings and thus alter the efficiency of the device.

Last but not least, milk residues that solidify inside the device can also negatively affect the organoleptic characteristics of the product and generate unpleasant malodorous exhalations.

For his reason, such devices can provide for the injection of liquid detergents for washing the internal parts which obviously must be carefully rinsed.

### SUMMARY

The technical task of the present invention is, therefore, to realize a device for frothing milk and a coffee machine including such device, which obviate the technical drawbacks described above of the prior art.

Within the scope of this technical task an object of the invention is to realize a device for frothing milk and a coffee machine that includes such device that allow to directly produce in the cup a wide range of products based on hot or cold-frothed milk with various frothing degrees.

Another object of the invention is to realize a device for frothing milk suitable for frothing also different types of milk, both of animal origin and of vegetable origin.

Another object of the invention is to make fully automatic the functions for the production of a wide range of milk-based products selectable by a user.

Another object of the invention is to realize a device for frothing milk easily inspectable and cleanable.

Another object of the invention is to make fully automatic also a function of accurate cleaning of the device selectable by a user.

Another object of the invention is to provide an extremely safe device for frothing milk.

The technical task, as well as these and other objects, according to the present invention are achieved by realizing a device for frothing milk characterized in that it comprises: a milk container provided with a lid with hermetic closure; a line for the pressurization of the container including an air supply pump; a line connecting the container to the external atmospheric environment including a shut-off valve means; a Venturi effect milk suction chamber; a line for the inlet of milk into the milk suction chamber, wherein said milk inlet line comprises a conduit for withdrawing milk from said container; a line for the inlet of steam into the milk suction chamber for initiating the Venturi effect and for sucking milk from the milk container, wherein said steam inlet line comprises a steam source; a line for the outlet of milk from the suction chamber; a milk frothing chamber connected to said milk outlet line and internally provided with a mechanical stirrer; and an external milk dispenser connected to said frothing chamber.

In an embodiment of the invention said milk suction chamber is incorporated in said lid. In an embodiment of the invention said milk frothing chamber is incorporated in said lid.

In an embodiment of the invention said milk frothing chamber is positioned above said milk suction chamber.

In an embodiment of the invention said lid comprises a chamber for accumulating the frothed milk interposed between said milk frothing chamber and said external milk dispenser.

In an embodiment of the invention said milk outlet line has a conveyor configured and arranged to pour milk from above directly on said mechanical stirrer.

In an embodiment of the invention said mechanical stirrer is supported by a removable wall of said lid.

In an embodiment of the invention said shut-off valve means comprises a solenoid valve.

In an embodiment of the invention said device for frothing milk comprises movement means for said mechanical stirrer.

In an embodiment of the invention said mechanical stirrer comprises a magnetic whip. In an embodiment of the invention said movement means comprises a magnetic rotor configured and arranged to drag said whip into a rotation with no contact.

In an embodiment of the invention said device for frothing milk comprises an electronic controller having beverage dispensing programs that include a state of selective activation of the air pump or of the steam source, wherein the state of activation of the air pump is envisaged in combination with a state of closure of said shut-off means, and wherein the state of activation of the steam source is envisaged in combination with a state of opening of said shut-off means.

In an embodiment of the invention said electronic controller has a cleaning program that includes a state of deactivation of the air pump, a state of activation of the steam source, a state of closure of said shut-off means and a state of activation of said mechanical stirrer.

The present invention also discloses a coffee machine including such a milk frothing device.

In an embodiment of the invention said device has removable connection means between a wall of said lid and a wall of said coffee machine.

In an embodiment of the invention said removable connection means includes fittings for the connection between sections of the air inlet line integrated into the lid and respectively into the coffee machine, between sections of the line connecting the container to the external atmospheric environment integrated into the lid and respectively into the coffee machine, and between sections of the steam inlet line integrated into the lid and respectively into the coffee machine.

In an embodiment of the invention said mechanical stirrer is positioned behind said wall of said lid and said movement means is positioned behind said wall of said coffee machine, at the same height as said mechanical stirrer.

### BRIEF DESCRIPTION OF THE DRAWINGS

Further features and advantages of the invention will become more apparent from the description of a non-exclusive embodiment thereof, of the device for frothing milk and of the machine that includes said device according to the invention, illustrated by way of non-limiting example in the drawings, in which:

FIG. 1 shows a front view of a coffee machine including the device for frothing milk;

FIG. 2 shows a front view of the coffee machine of FIG. 1 from which the milk container was removed;

FIG. 3a shows a side elevation view in vertical section of the coffee machine of FIG. 1 where the components of the device for frothing milk are highlighted, where the milk container provided with lid is removed from the front wall of the coffee machine;

FIG. 3b shows a side elevation view in vertical section of the coffee machine of FIG. 1 where the components of the device for frothing milk are highlighted, where the milk container provided with lid is connected to the front wall of the coffee machine;

FIGS. 4 and 5 show axonometric views of the milk container provided with lid of the device for frothing milk;

FIG. 6 shows an exploded view of the container provided with lid;

FIGS. 7 and 8 show axonometric views of the removable wall of the lid on which the mechanical stirrer is mounted; and

FIGS. 9, 10 and 11 show different vertical sections of the milk container provided with lid of the device for frothing milk.

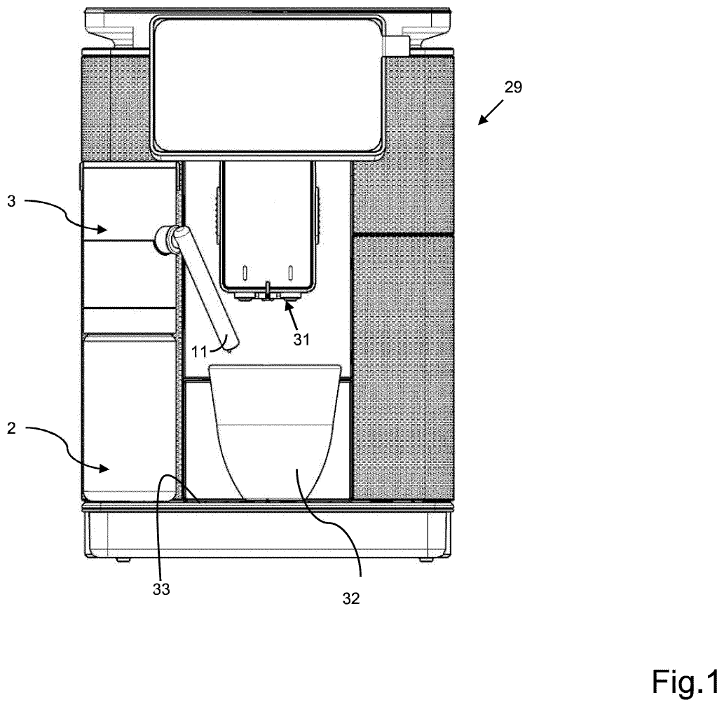

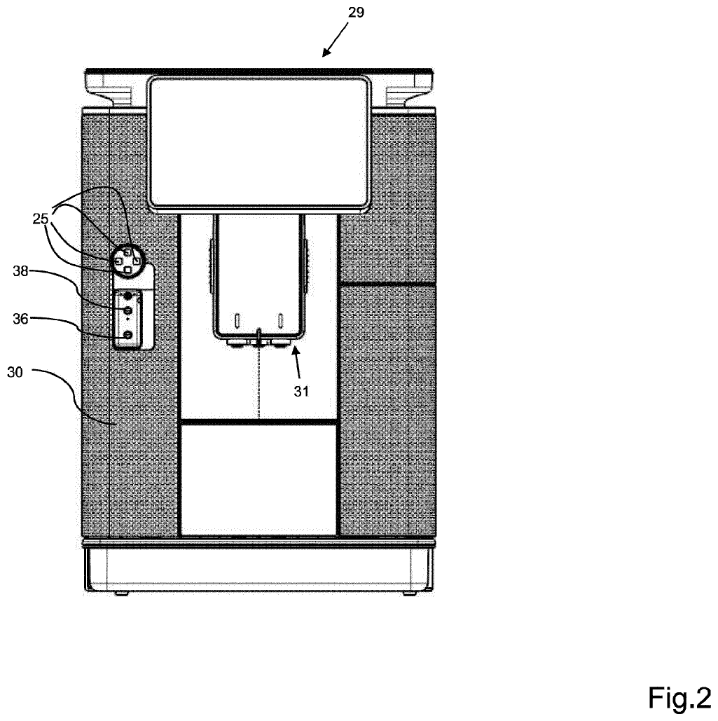

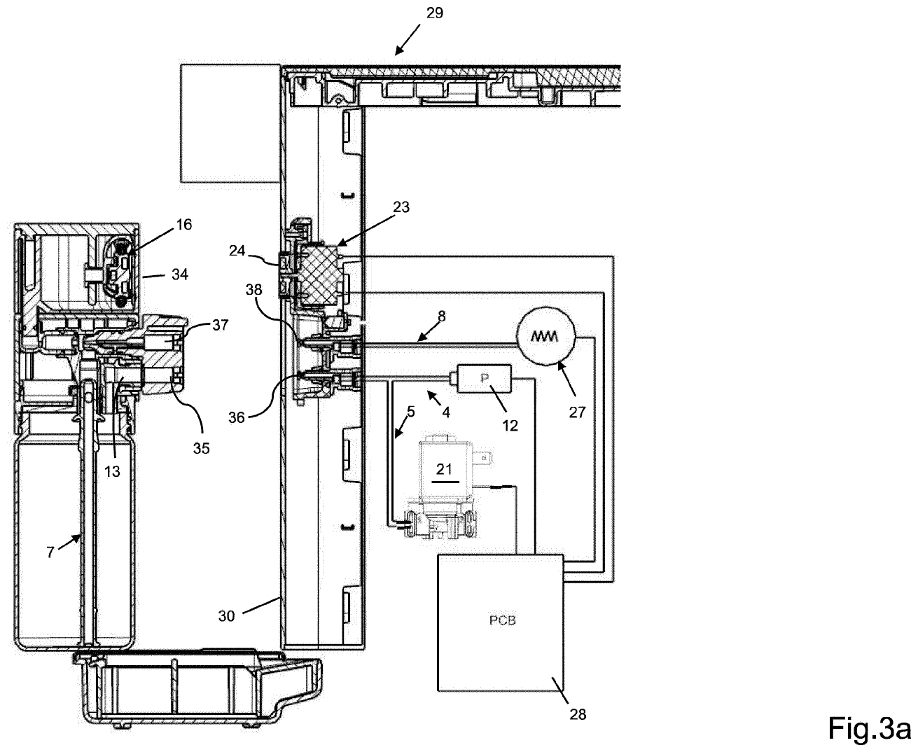

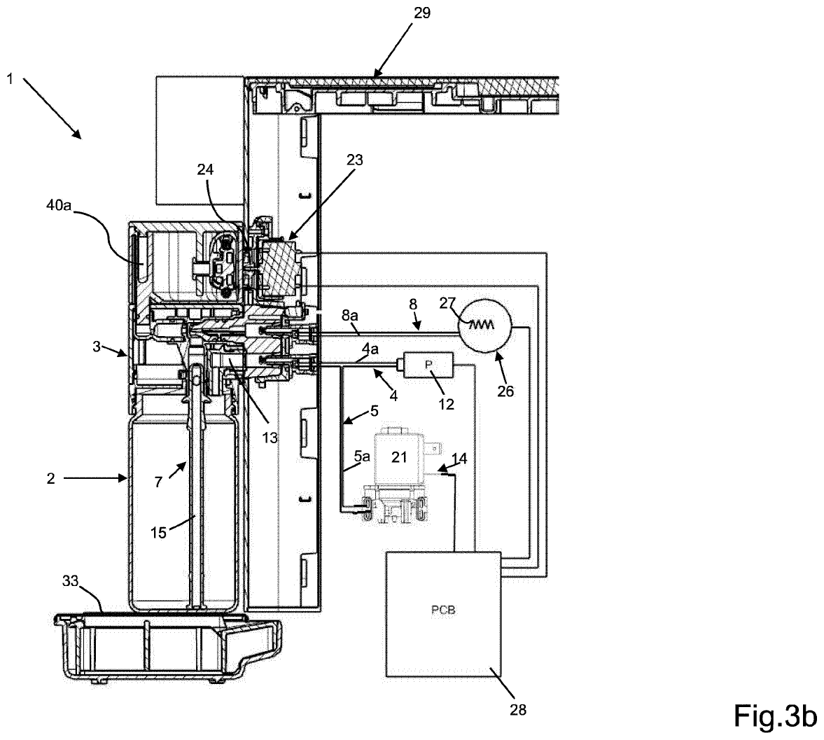

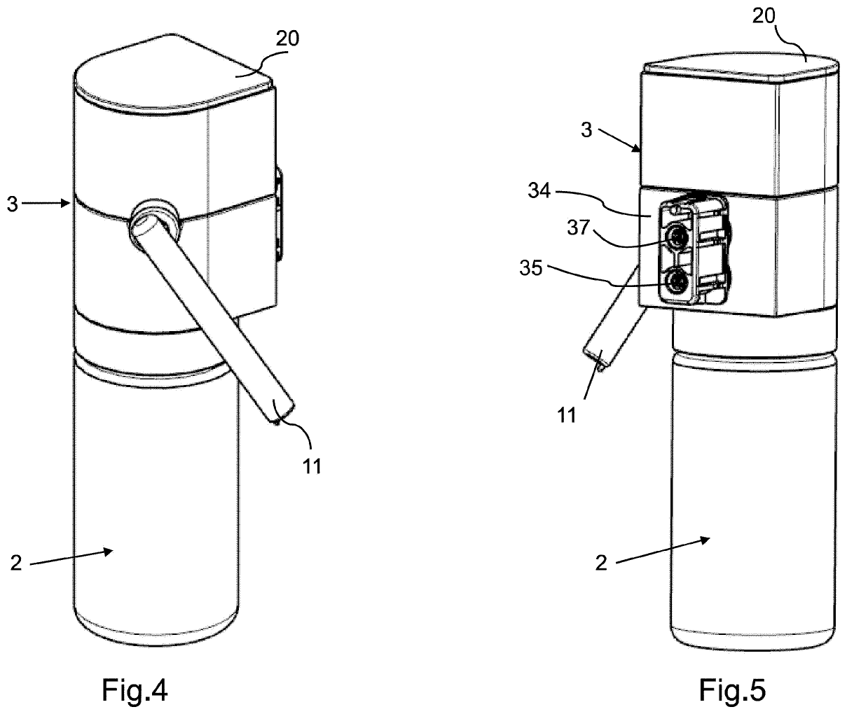

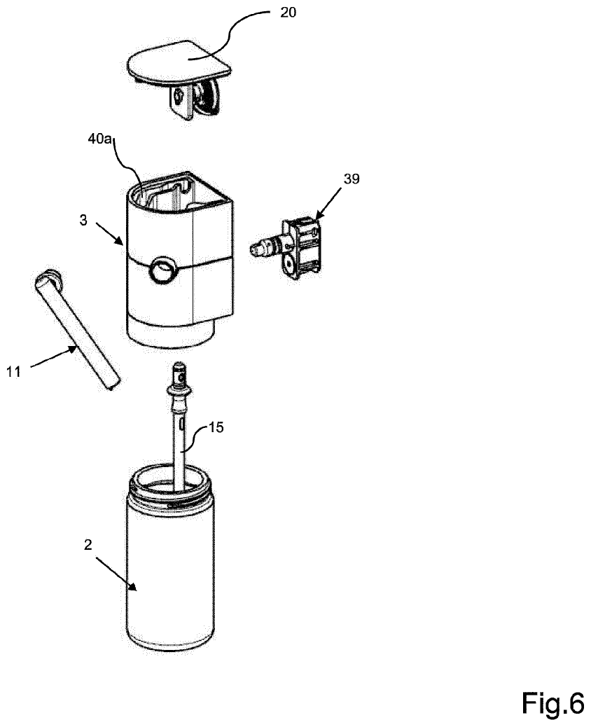

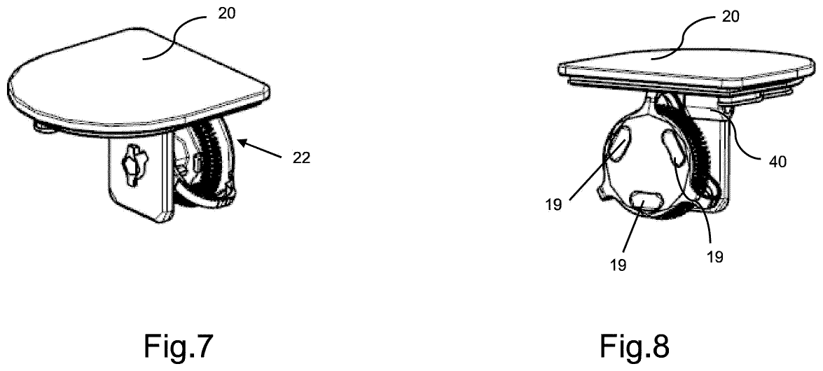

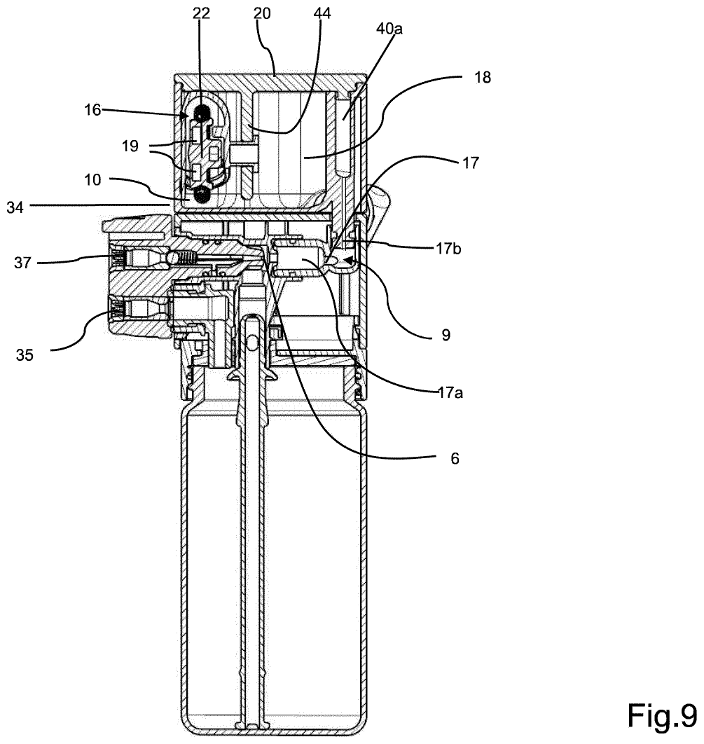

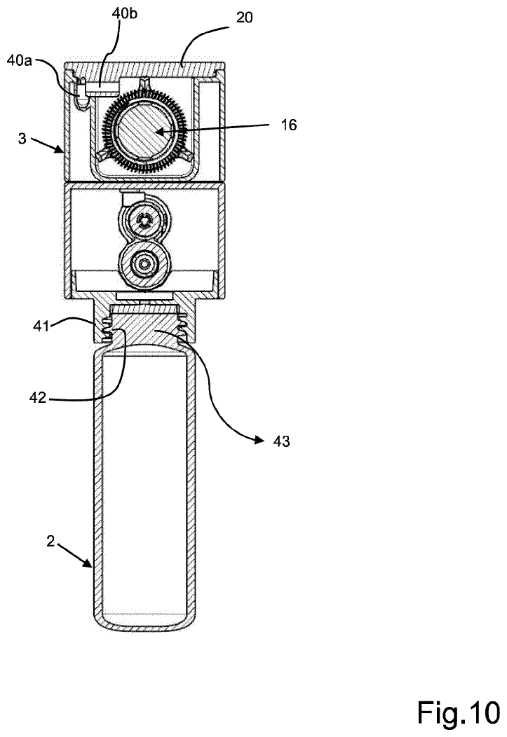

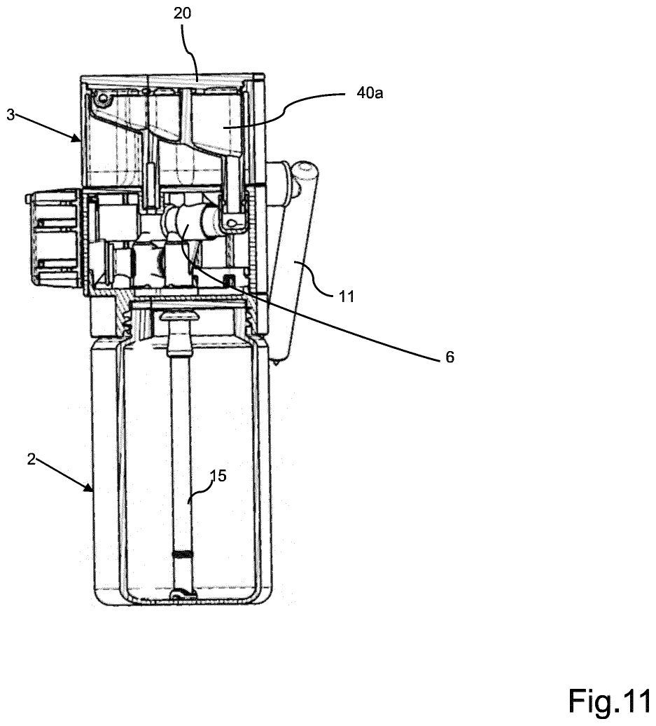

### DETAILED DESCRIPTION

With reference to the aforementioned figures, a device for frothing milk indicated as a whole with reference numeral 1 is shown.

The device 1 comprises a milk container 2 provided with a hermetic lid 3.

The lid 3 can be removed from the container 2 to refill the container 2 with fresh milk once it is empty.

For example, a screw coupling may be provided between a thread of the lid 3 and a counter thread 42 of a neck 43 of the container 2.

The lid 2 has a hollow structure to house inside it, as we will see, some components of the device 1.

The device 1 comprises a line for the pressurization of the container 4, a line 5 connecting the container 2 to the external atmospheric environment, a Venturi effect milk suction chamber 6, a line 7 for the inlet of milk into the milk suction chamber 6, a line 8 for the inlet of steam into the milk suction chamber 6 for initiating the Venturi effect and for sucking milk from the milk container 2, a line 9 for the outlet of milk from the suction chamber, a milk frothing chamber 10 connected to the milk outlet line 9, and an external milk dispenser 11 connected to the frothing chamber 10.

The pressurization line 4 of the container 2 includes a pump 12 for the supply of air to the container 2.

Air is introduced into the container 2 above the free surface of the milk through an air conduit 13 which passes through the lid 3 and is introduced from above into the container 2.

The line 5 connecting the container 2 to the external atmospheric environment includes shut-off valve means 14.

The shut-off valve means specifically comprises a solenoid valve 21.

The line 7 for the inlet of milk in the milk suction chamber 6 comprises a conduit 15 for withdrawing milk from the container 2.

The withdrawal conduit 15 extends vertically as far as the bottom of the container 2. The steam inlet line 8 comprises a steam source 26, specifically a boiler 27.

The steam inlet line 8 is configured to introduce into the suction chamber 6 a horizontal flow of steam recalling a vertical upward flow of milk along the withdrawal conduit 15.

The suction chamber 6 of the milk is incorporated in the lid 3.

The milk frothing chamber 10 is internally provided with a mechanical stirrer 16.

The mechanical stirrer 16 specifically comprises a magnetic whip 22, particularly a ring whip, which ring is made of wire wrapped as a propeller.

The whip 22 is magnetic in that it is made of a magnetic metallic material or in that it incorporates magnetic inserts 19, for example formed by permanent magnets.

The mechanical stirrer 16 is supported by a removable wall 20 of the lid 3.

This allows a safe use of the device 1, in that if the device 1 is activated in the absence of having repositioned the wall 20 of the lid 3, it is not possible to activate the mechanical stirrer 16 and it is therefore avoided that this may generate splashes of hot milk towards the user.

The device 1 comprises movement means 23 for the mechanical stirrer 16.

The movement means 23 comprises a magnetic rotor 24 configured and arranged to drag the magnetic whip 22 in rotation with no contact.

The magnetic rotor 24 includes an electric motor whose output shaft rotatably supports the magnetic rotor 24.

The rotor 24 is magnetic in that it incorporates magnetic inserts 25, e.g. permanent magnets, magnetically interacting with the whip 22.

The magnetic whip 22 and the magnetic rotor 24 are positioned with horizontal coaxial axes of rotation.

The movement means may be configured to rotate the mechanical stirrer 16 at different speeds.

For example, the electric motor is an alternating current motor driven by an inverter. The milk frothing chamber 10 is also incorporated into the lid 3.

The milk frothing chamber 10 is positioned above the milk suction chamber 6.

The milk outlet line 9 has an angular conduit 17 having a horizontal section 17a fed by the suction chamber 6 and an upward vertical section 17b, and a conveyor 40a, 40b fed by the angular conduit 17 and feeding the frothing chamber 10.

The conveyor 40a, 40b comprises an upwardly inclined manifold with open ceiling 40a apically presenting a mouth 40b for pouring milk from above directly on the mechanical stirrer 16 in such a way as to guarantee an immediate milk frothing.

The mouth 40b is made in a single piece with the removable wall 20 of the lid 3 while the inclined manifold 40a is made in a single piece with a non-removable wall of the lid 3.

The lid 3 further comprises a chamber 18 for accumulating the frothed milk which is interposed between the milk frothing chamber 10 and the external milk dispenser 11.

The accumulation chamber 18 and the frothing chamber 10 are separated by a transverse appendage 44 of the removable wall 20, particularly a transverse appendage 44 supporting the axis of rotation of the mechanical stirrer 16.

The device 1 finally comprises an electronic controller 28 to which the air pump 12, the solenoid valve 21, the electric motor of the magnetic rotor 24 and the boiler 27 are connected.

The electronic controller 28 is specifically in the form of a PCB board.

The device 1 can be integrated into a coffee machine 29.

In this case the electronic controller 28 may be the same as normally provided in the coffee machine 29.

The coffee machine 29 usually has a hydraulic circuit (not shown) which provides in cascade a water source, a water feeding pump, a boiler and an infuser.

The hydraulic circuit of the coffee machine 29 also comprises a steam production line, which may employ the above boiler 27 or a dedicated boiler for the purpose.

The water source can be a tank integrated into the coffee machine or a connection to the water mains.

The infuser is connected to an external coffee dispenser 31 supported by a front wall 30 of the coffee machine 29.

The external coffee dispenser 31 can dispense the beverage directly into a cup 32 below positioned on a front plane 33 for resting cups of the coffee machine 29.

The device 1 as mentioned may share some resources with the coffee machine 29, including the electronic controller 28.

For example, as mentioned, the boiler 27 can also be the one normally provided in the hydraulic circuit of the coffee machine for the production of steam.

The device 1 has removable connection means between a wall 34 of the lid 3 and a wall of the coffee machine 29, specifically the front wall 30 of the coffee machine 29.

The removable connection means includes fittings for the connection between sections of the air inlet line 4 integrated into the lid 3 and respectively into the coffee machine 29, between sections of the line 5 connecting the container 2 to the external atmospheric environment integrated into the lid 3 and respectively into the coffee machine 29, and between sections of the steam inlet line 8 integrated into the lid 3 and respectively into the coffee machine 29.

More precisely, the air inlet line 4 and the line 5 connecting the container 2 to the external atmospheric environment share a section integrated in the lid 3.

The shared section includes the air conduit 13 which is connected to a first fitting 35 provided on the wall 34 of the lid 3.

The first fitting 35 is in turn engageable with a first terminal 36 provided on the front wall 30 of the coffee machine 29.

The sections 4a and 5a of the air inlet line 4 and of the connection line 5 of the container 2 to the atmospheric environment extend inside the coffee machine 29 from the first terminal 36.

The section 4a of the air inlet line includes the air pump 12, while the section 5a of the line connecting the container 2 to the external atmospheric environment includes the shut-off valve means 14.

The section of the steam inlet line 8 integrated in the lid 3 is connected to a second fitting 37 provided on the wall 34 of the lid 3.

The second fitting 37 is in turn engageable with a second terminal 38 provided on the front wall 30 of the coffee machine 29.

The section 8a of the steam inlet line 8 including the steam source 26 extends inside the coffee machine 29 from the second terminal 38.

The first fitting 35 and the second fitting 37 may be made as a block 39 removably engaged in a housing of the wall 34 of the lid 3.

The mechanical stirrer 16 is positioned behind the wall 34 of the lid 3 and the movement means 23 is positioned behind the front wall 30 of the coffee machine 29, at the same height as the mechanical stirrer 16.

In practice, between the two walls 30, 34, which are conveniently vertical and flat, there is an interface area 2 where the connections between the lid 3 and the coffee machine 29 necessary for the operation of the device 1 are located.

The terminals 37, 38 are engageable in the respective fittings 35, 36 by means of a horizontal coupling.

In the position of coupling of the terminals 37, 38 in the respective fittings 35, 36 the container 2 rests on the plane 33.

The plane 33 can then be used as a guide for the coupling of the terminals 37, 38 in the respective fittings 35, 36.

The operation of the device 1 according to the invention is evident from what is described and illustrated and, in particular, is substantially the following.

The user can perform a manual selection of a beverage through a special user interface provided by the device 1, and may be integrated in the coffee machine 29, particularly in the dashboard that the coffee machine 29 normally provides.

In the event that the user selects the dispensing of a frothed cold milk, the electronic controller 28 executes a dispensing program that provides for the solenoid valve 21 deactivated which corresponds to the closure of the communication of the line 5 with the external atmospheric environment, the steam source 27 activated, the air pump 12 activated, and the electric motor of the rotor 23 activated.

The air pump 12 pressurizes the air head present in the container 2 above the free surface of the milk and the air pressure on the free surface of the milk results in an upward thrust of the milk from the tube 15 towards the suction chamber 6 and therefrom to the frothing chamber 10 where the mechanical stirrer 16 frothing the milk which is then dispensed is operating.

The temperature of the dispensed milk remains substantially that of the milk present in the container 2.

In the event that the user selects the dispensing of a cold milk without foam, the electronic

controller 28 executes a dispensing program that provides for the solenoid valve 21 deactivated which corresponds to the closure of the communication of the line 5 with the external atmospheric environment, the steam source 27 activated, the air pump 12 activated, and the electric motor of the rotor 23 deactivated.

The air pump 12 pressurizes the air head present in the container 2 above the free surface of the milk and the air pressure on the free surface of the milk causes an upward thrust of the milk from the tube 15 towards the suction chamber 6 and therefrom to the frothing chamber 10 where the mechanical stirrer 16, being inactive, does not froth the milk which is then dispensed.

In the event that the user selects the dispensing of a hot frothed milk, the electronic controller 28 executes a dispensing program that provides for the solenoid valve 21 activated which corresponds to the opening of the communication of the line 5 with the external atmospheric environment, the steam source 27 activated, the air pump 12 deactivated, and the electric motor of the rotor 23 activated.

The steam flow initiates the Venturi effect in the suction chamber 6 and the milk sucked from the container 2 through the tube 15 rises to the suction chamber 6 and from this to the frothing chamber 10 where the mechanical stirrer 16 frothing the milk which 1s then dispensed 1s operating.

The continuous rise of the milk from the tube 15 occurs due to the fact that the milk container 2 is maintained at atmospheric pressure thanks to the connection to the external atmospheric environment guaranteed by the open solenoid valve 21.

The thermal energy of the steam, in addition to initiating the Venturi effect, is used in this case for heating the milk.

In the event that the user selects the dispensing of a hot milk without foam, the electronic controller 28 executes a dispensing program that provides for the solenoid valve 21 activated, the steam source 27 activated, the air pump 12 deactivated, and the electric motor of the rotor 23 deactivated.

The steam flow initiates the Venturi effect in the suction chamber 6 and the milk sucked from the container 2 through the tube 15 rises to the suction chamber 6 and therefrom to the frothing chamber 10 where the mechanical stirrer 16 is not in operation and therefore does not froth the milk that is then dispensed.

The user can also select a cleaning function.

In the event that the user selects the cleaning function, the electronic controller 28 executes a cleaning program that provides for the solenoid valve 21 deactivated which corresponds to the closure of the communication of the line 5 with the external atmospheric environment, the steam source 27 activated, the air pump 12 deactivated, and the electric motor of the rotor 23 activated. The steam flow runs through the suction chamber 6, reaches the frothing chamber 10 and in sequence the accumulation chamber 18 to be expelled from the external dispenser 11.

The steam flow is not able to suck milk from the container 2 as the closure of the solenoid valve 21 creates a depression in the container 2 equal to the depression created by the steam flow in the suction chamber 6 for the Venturi effect.

The device 1 has a very high flexibility of use.

Since the milk dispenser 11 can be oriented to dispense directly into the same cup 32 where the coffee dispenser 31 dispenses, the user can obtain a beverage with a simple manual selection operation on the user interface.

Selectable and producible milk-based beverages are of various kinds.

Cold beverages can be obtained typically with temperatures between 3° C. and 10° C. using refrigerated milk and dispensing programs that provide for the activation of the air pump 12.

Hot beverages can be obtained typically with temperatures between 50° C. and 75° C. using dispensing programs that provide for the activation of the boiler 27.

Beverages with varying proportions between milk and coffee can be obtained simply by providing dispensing programs with different duration of activation of the air pump 12 for cold beverages and of the boiler 27 for hot beverages.

Beverages with or without foam can be obtained simply by providing dispensing programs with or without activation of the mechanical stirrer 16.

Different rotation speeds of the mechanical stirrer 16 can be used for different temperatures of the milk to be frothed, in the same type of milk used, since the temperature of the milk to be frothed has an established influence on frothing.

Beverages based on different types of animal and vegetable milk can be obtained simply by providing dispensing programs with different rotation speed of the mechanical stirrer 16.

In this way the milk frothing is optimized even when the content thereof in fats, proteins, carbohydrates varies, which has a proven influence on milk frothing.

For example, a whole cow milk dispensing program, due to the high fat and protein content, may provide for a rotational speed of the mechanical stirrer 16 in the order of 3000 rpm, a skimmed cow milk dispensing program may provide for a rotational speed of the mechanical stirrer 16 in the order of 6000 rpm for a milk to be frothed having a temperature between 3° C. and 10° C. and in the order of 5000 rpm for a milk to be frothed having a temperature between 50° C. and 75° C. Finally, beverages of various flavorings can be obtained simply by providing dispensing programs with different additives or flavors based on chocolate, vanilla, strawberry or more.

The additives or flavors, in powder or liquid form, can be added to the milk in the container 2 or can even be poured directly into the frothing chamber, removing the wall 20 of the lid 3.

The conceived device for frothing milk is susceptible to numerous modifications and variations, all falling within the scope of the inventive concept; moreover, all the details can be replaced by technically equivalent elements.

In practice, the materials used, as well as the dimensions, can be any depending on the needs and the state of the art.

1. A device for frothing milk comprising: a milk container provided with a lid with hermetic closure; a line for the pressurization of the container including an air supply pump; a line connecting the container to the external atmospheric environment including a shut-off valve; a Venturi effect milk suction chamber; a line for the inlet of milk into the milk suction chamber, wherein said milk inlet line comprises a conduit for withdrawing milk from said container; a line for the inlet of steam into the milk suction chamber for initiating the Venturi effect and for sucking milk from the milk container, wherein said steam inlet line includes a steam source; a line for the outlet of milk from the suction chamber; a milk frothing chamber connected to said milk outlet line and internally provided with a mechanical stirrer; and an external milk dispenser connected to said frothing chamber.

2. The device for frothing the milk according to claim 1, wherein said milk suction chamber is incorporated into said lid.

3. The device for frothing the milk according to claim 1, wherein said milk frothing chamber is incorporated into said lid.

4. The device for frothing the milk according to claim 3, wherein said milk frothing chamber is positioned above said milk suction chamber.

5. The device for frothing the milk according to claim 1, wherein said lid comprises a chamber for accumulating the frothed milk which is interposed between said milk frothing chamber and said external milk dispenser.

6. The device for frothing the milk according to claim 1, wherein said milk outlet line has a conveyor configured and arranged to pour the milk from above directly on said mechanical stirrer.

7. The device for frothing the milk according to claim 3, wherein said mechanical stirrer is supported by a removable wall of said lid.

8. The device for frothing the milk according to claim 1, wherein said shut-off valve comprises a solenoid valve.

9. The device for frothing milk according to claim 1, further comprising a movement means for said mechanical stirrer, wherein said mechanical stirrer comprises a magnetic whip and said movement means comprises a magnetic rotor configured and arranged to drag said whip into a rotation with no contact.

10. The device for frothing milk according to claim 1, further comprising an electronic controller having beverage dispensing programs that include a state of selective activation of the air pump or of the steam source, wherein the state of activation of the air pump is envisaged in combination with a state of closure of said shut-off valve, and wherein the state of activation of the steam source is envisaged in combination with a state of opening of said shut-off valve.

11. The device for frothing milk according to claim 10, wherein said electronic controller has a cleaning program that includes a state of deactivation of the air pump, a state of activation of the steam source, a state of closure of said shut-off means and a state of activation of said mechanical stirrer.

12. A coffee machine including the device for forthing milk according to claim 1.

13. The coffee machine according to claim 12, wherein said device for frothing milk comprises a removeable connection between a wall of said lid and a wall of said coffee machine.

14. The coffee machine according to claim 13, wherein said removable connection includes fittings for the connection between sections of the air inlet line integrated into the lid and respectively into the coffee machine, between sections of the line connecting the container to the external atmospheric environment integrated into the lid and respectively into the coffee machine, and between sections of the steam inlet line integrated into the lid (3) and respectively into the coffee machine.

15. The coffee machine according to claim 12, wherein said mechanical stirrer is positioned behind said wall of said lid and said movement means is positioned behind said wall of said coffee machine, at the same height as said mechanical stirrer.
